(19) United States
(12) Patent Application Publication
(10) Pub. No.: US 2017/0018849 A1
(43) Pub. Date: Jan. 19, 2017

(54) ANTENNA AND RELATED METHOD

(71) Applicant: Kabushiki Kaisha Toshiba, Tokyo (JP)

(72) Inventor: Sema DUMANLI OKTAR, Bristol (GB)

(21) Appl. No.: 15/125,043

(22) PCT Filed: Jul. 22, 2015
(86) PCT No.: PCT/GB2015/052121

§ 371 Date: Sep. 9, 2016

(30) Foreign Application Priority Data
Jul. 22, 2014 (GB) PCT/GB2014/052231

(51) Int. Cl. H01Q 9/04; H01Q 3/22; H01Q 1/27

(52) U.S. Cl. CPC H01Q 9/045; H01Q 9/0421; H01Q 1/273; H01Q 3/22

(57) ABSTRACT

In an embodiment an antenna comprising a planar patch radiator is disclosed. The planar patch radiator, on excitation by an input signal having a first frequency within a predetermined frequency range, is operable in a first radiation mode with a first radiation pattern. On excitation by an input signal having a second frequency within the frequency range the planar patch radiator is operable in a second radiation mode with a second radiation pattern.

### FIELD

Embodiments described herein relate generally to antennas and methods of manufacturing antennas and in particular to antennas having a radiation pattern which can be changed by changing frequency channels.

### BACKGROUND

A body area network (BAN) is a wireless network of wearable devices. A typical body area network includes a number of sensors worn by, or implanted in, a patient which monitor the patient's vital signs. The information gathered by the sensors may be collected by a relay device, also worn by the patient, and transmitted to an external processing unit.

On body antenna design is a challenging task due to the influence of the body on the radiation emitted by the antenna. The antenna should be designed to have a more application dependent gain pattern and to be less sensitive to near field effects of the body. There are different requirements for on-body and off-body links. For the case of on-body links, the antenna radiation should be directed along the body (omni-directional in horizontal plane) with vertical polarization in addition to antenna being conformal to the body. For the case of off-body links, the antenna radiation should be directed away from the body while polarisation is not as critical as the on-body case.

### BRIEF DESCRIPTION OF THE DRAWINGS

In the following, embodiments will be described by way of example with reference to the drawings in which:

FIG. 1 shows radiation patterns of an antenna according to an embodiment;

FIG. 2 shows an antenna according to an embodiment;

FIGS. 3a and 3b show vector representations of the electric field for an embodiment of an antenna when operating in different modes;

FIGS. 4a to 4b show the three dimensional simulated radiation patterns for an antenna according to an embodiment at different frequencies;

FIG. 5 shows the frequency characteristics of an antenna according to an embodiment;

FIGS. 6a and 6b show the radiation pattern of an antenna according to an embodiment;

FIG. 7 shows an antenna according to an embodiment;

FIGS. 8a to 8b show the three dimensional simulated radiation patterns for an antenna according to an embodiment at different frequencies;

FIG. 9 shows the frequency characteristics of an antenna according to an embodiment;

FIGS. 10a and 10b show the radiation pattern of an antenna according to an embodiment; and

FIG. 11 shows a method of manufacturing an antenna according to an embodiment.

### DETAILED DESCRIPTION

In an embodiment an antenna comprising a planar patch radiator is disclosed. The planar patch radiator, on excitation by an input signal having a first frequency within a predetermined frequency range, is operable in a first radiation mode with a first radiation pattern. On excitation by an input signal having a second frequency within the frequency range the planar patch radiator is operable in a second radiation mode with a second radiation pattern. The first and second frequency modes are in the same frequency range and may overlap each other.

In an embodiment the first radiation pattern is an omni-directional pattern and the second radiation is a directional radiation pattern.

In an embodiment the predetermined frequency range is a frequency band reserved for use by cellular phones, for use in WLAN/WiFi/the 802.11 standard and/or the industrial, scientific and medical (ISM) radio bands.

In the embodiment an radiator has a fractional bandwidth of less than 20%, or approximately or less than 10% or approximately or less than 5%.

In an embodiment the antenna is configured for use in a body area network, wherein the first mode is an on-body mode and the second mode is an off-body mode.

In another embodiment a body area network that comprises one or more of the aforementioned antenna is disclosed.

In an embodiment a method of operating an antenna that comprises a planar patch radiator is disclosed. The method comprises operating the radiator in a first radiation mode with a first radiation pattern by exciting the radiator using an input signal having a first frequency within a predetermined frequency range and operating the radiator in a second radiation mode with a second radiation pattern by exciting by an input signal having a second frequency within the frequency range.

In an embodiment the first radiation pattern is an omni-directional pattern and the second radiation is a directional radiation pattern.

In an embodiment the predetermined frequency range is a frequency band reserved for use by cellular phones, for use in WLAN/WiFi/the 802.11 standard and/or the industrial, scientific and medical (ISM) radio bands.

In an embodiment the radiator has a fractional bandwidth of less than 20% or approximately or less than 10% or approximately or less than 5%.

In an embodiment the antenna is used in a body area network, wherein the first mode is an on-body mode and the second mode is an off-body mode.

In an embodiment a method of manufacturing an antenna is disclosed. The method comprises selecting an operating frequency range; identifying a first radiation mode and a second radiation mode of a radiator; determining a configuration of the radiator in which a first frequency within the operating frequency range excites the first radiation mode and a second frequency within the operating frequency range excites the second radiation mode; and making an antenna having a radiator according to the determined configuration.

In an embodiment the radiator is a planar patch radiator.

In an embodiment determining the configuration comprises selecting locations for shorting pins which couple the planar patch radiator to a ground plane.

In an embodiment the configuration comprises selecting a location for a feed point.

In an embodiment determining the configuration comprises determining a feed arrangement for a feed element for coupling an input signal to two feed points such that a phase difference between the input signal at the two feed points depends on the frequency of the input signal.

In an embodiment the feed arrangement is determined such that the phase difference between the input signal is less than 90 degrees for a first frequency within the operating frequency range and greater than 90 degrees for a second frequency within the operating frequency range.

In an embodiment the first radiation mode has an omni-directional pattern and the second radiation mode has a directional radiation pattern.

In an embodiment an antenna is disclosed. The antenna comprises a planar patch radiator; a ground plane; a plurality of shorting pins coupling the planar patch radiator to the ground plane; and a feed element configured to couple an input signal with a feed point on the planar patch radiator, the feed point being offset from the centre of the planar patch radiator and further from the edges of the planar patch radiator than the shorting pins.

In an embodiment the planar patch radiator, on excitation by an input signal having a first frequency within an operating frequency range is operable in a first radiation mode with a first radiation pattern, and on excitation by an input signal having a second frequency within the operating frequency range is operable in a second radiation mode with a second radiation pattern.

In an embodiment the first radiation pattern is an omni-directional pattern and the second radiation is a directional radiation pattern.

In an embodiment the antenna is configured for use in a body area network, wherein the first mode is an on-body mode and the second mode is an off-body mode.

In an embodiment an antenna is disclosed. The antenna comprises a planar patch radiator; and a feed element comprising a first path, having a first path length, and configured to couple an input signal to a first feed point on the planar patch radiator;

and a second path, having a second path length different from the first path length, and configured to couple the input signal to a second feed point on the planar patch radiator, the first path length and the second path length being selected such that a phase difference input signal at the two feed points is less than 90 degrees at a first frequency within an operating frequency range and the phase difference between the input signal at the two feed points is greater than 90 degrees at the second frequency within the operating frequency range.

In an embodiment the planar patch radiator, on excitation by an input signal having the first frequency within an operating frequency range is operable in a first radiation mode with a first radiation pattern, and on excitation by an input signal having the second frequency within the operating frequency range is operable in a second radiation mode with a second radiation pattern.

In an embodiment the first radiation pattern is an omni-directional pattern and the second radiation is a directional radiation pattern.

In an embodiment the antenna is configured for use in a body area network, wherein the first mode is an on-body mode and the second mode is an off-body mode.

Embodiments described herein relate to antennas which enable the radiation pattern of the antenna to be steered by changing the channels of the operating frequency band. A certain number of channels can be allocated for a certain radiation pattern.

If there is an expected behaviour for an application, the channels achieving the suitable radiation pattern can be pre-allocated for that application.

For example, if a body area network (BAN) device needs to connect to other devices both on the body and off-body, the radiation pattern suitable for on-body and off-body communication can be assigned to certain channels and the suitable channels can be used for each link.

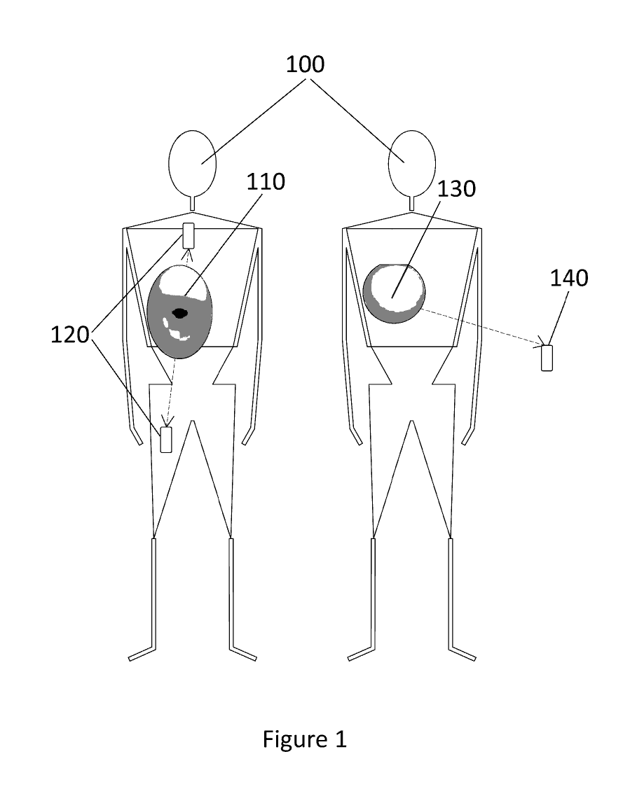

FIG. 1 shows the radiation patterns of an antenna according to an embodiment. The antenna is located on the body of a patient 100. When the antenna is operating in an on-body mode, for example to communicate with other devices 120 located on the patient's body, an omni-direction radiation pattern 110 is transmitted in which the radiofrequency radiation is transmitted mainly in a horizontal plane. When the antenna is operating in an off-body mode, for example to send signals to an off-body device 140, a directional radiation pattern 130 is produced.

In embodiments described below, the antenna can be switched between different radiation modes by changing frequency channels within the operating frequency band. Embodiments have the advantage where different radiation patterns are needed for different operations of a simple device. Embodiments realize simple structures with a single radiator and a simple control mechanism. In embodiments, by optimizing the dimensions and configuration of the antenna, different radiation modes are pushed to the same frequency band and then a favoured radiation pattern suitable for the application is selected by making the channel selection at higher levels. Embodiments provide a simple structure making use of a single radiator and which eliminates any switching mechanism at the physical layer.

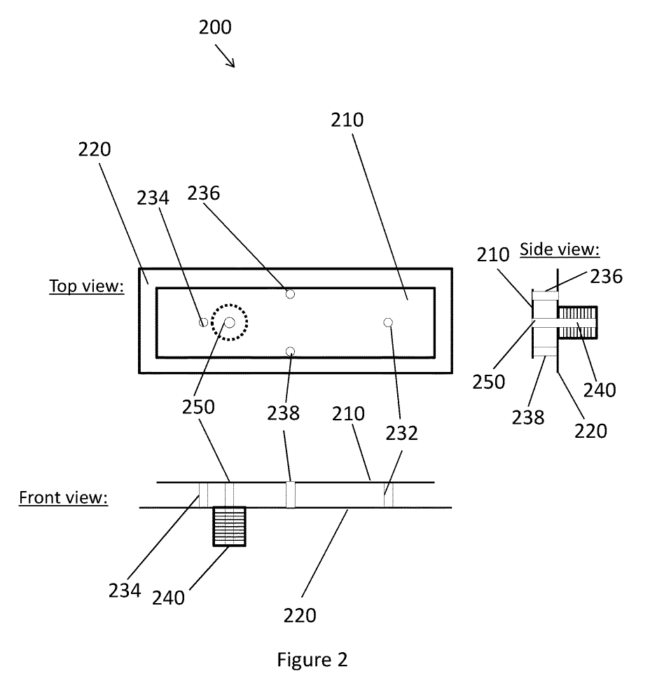

FIG. 2 shows an antenna 200 according to an embodiment. The antenna 200 comprises a conductive patch radiator 210 and a conductive ground plane 220. The patch radiator 210 is rectangular and planar. It is arranged parallel to the ground plane 220 which is rectangular in shape. The ground plane 220 has a larger width and breath than the patch radiator 210. The patch radiator 210 is arranged with its centre over the centre of the ground plane 220 so that when viewed from above, a part of the ground plane 220 extends beyond each of the edges of the patch radiator 210.

Four shorting pins 232 234 236 238 electrically connect the patch radiator 210 to the ground plane 220. A first longitudinal shorting pin 232 and a second longitudinal shorting pin 234 are arranged at points equal distances from the centre of the patch radiator on the longitudinal axis (the axis running through the centre and parallel to the longer sides of the rectangular patch radiator). A first transverse shorting pin 236 and a second transverse shorting pin 238 are arranged at points equal distances from the centre of the patch radiator on the transverse axis (the axis running through the centre and parallel to the shorter sides of the rectangular patch radiator).

An input signal is coupled to the antenna 200 by co-axial connector 240, which connects the input signal to a feed point 250 on the patch radiator 210. The feed point 250 lies on the longitudinal axis between the first longitudinal shorting pin 232 and the second longitudinal shorting pin 234. The feed point 250 is offset from the centre of the patch radiator so it lies closer to the second longitudinal shorting pin 234 than the first longitudinal shorting pin 232.

The dimensions and configuration of the antenna 200 are selected to push the frequencies of two different modes into the same frequency band.

The position of the longitudinal shorting pins 232 & 234 affects the frequency of the both modes. Therefore it can be used to tune the whole structure. As the pins 232 & 234 are moved away from the centre, the operating frequency of both modes increases.

The position of the transverse shorting pins 236 & 238 does not have any effect on the directional mode. It affects the matching and the resonant frequency of the omnidirectional mode. The resonant frequency increases as the pins 236 & 238 are moved away from the centre.

The position of the feed point 250 should be between the shorting pins and the centre in order to excite both modes. The optimum position is found through parametric analysis. It is noted that in order to excite both modes, the feed point 250 must be offset from the centre. If the feed is central, then the directional mode cannot be excited. If the feed is closer to the edge than the shorting pins, then the omnidirectional mode cannot be excited. For the embodiment shown in FIG. 2, the only way to excite both modes is to excite between the central point and the longitudinal shorting pins 232 & 234.

The shorter edge of the patch radiator 210 is not the resonant edge for the directional mode therefore it has a stronger effect on the resonant frequency of the omni-directional mode. By decreasing the length of the short edge, the operating frequency of the omnidirectional mode can be increased toward the directional mode. The operating frequency of the omni-directional mode is dictated by the overall circumference.

In an embodiment, the antenna is configured for use in the 2.4 GHz ISM band. 2.6 dB maximum gain is observed for the on-body (omni-directional) mode at 2.4 GHz and 5.8 dB maximum gain for the off-body (directional) mode is observed at 2.48 GHz for an antenna with the following dimensions: separation of patch radiator and ground plane 4.8 mm; dimensions of ground plane 45 mm×14 mm; transverse shorting pins separated by 7.6 mm; longitudinal shorting pins separated by 21.8 mm; feed point located on longitudinal axis 8 mm from centre of patch radiator.

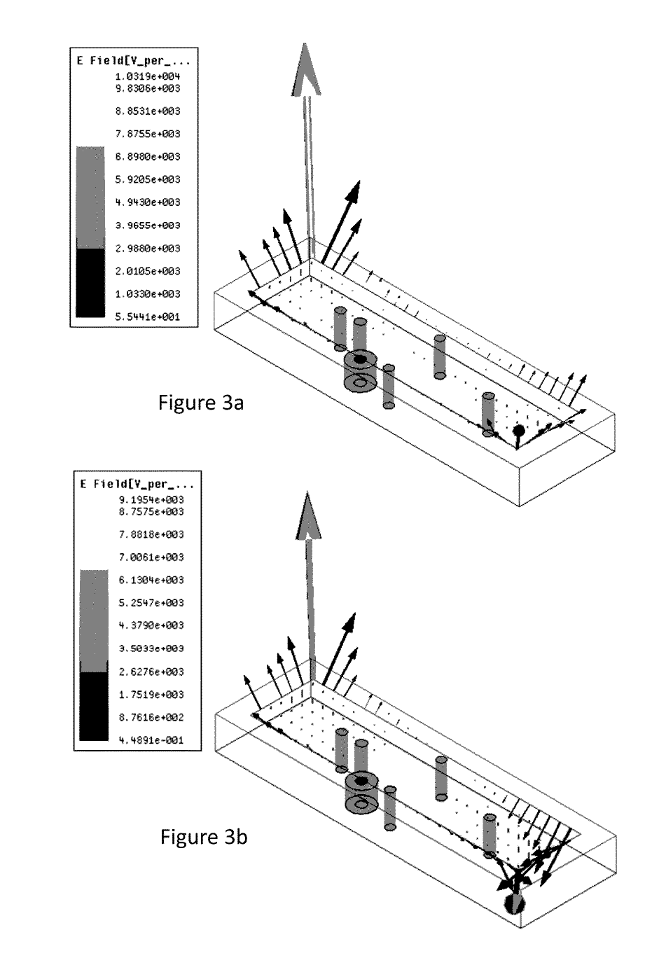

FIG. 3a shows the vector representation of the electric field for the omni-directional mode for the embodiment of an antenna shown in FIG. 2.

FIG. 3b shows the vector representation of the electric field for the directional mode for the embodiment of an antenna shown in FIG. 2.

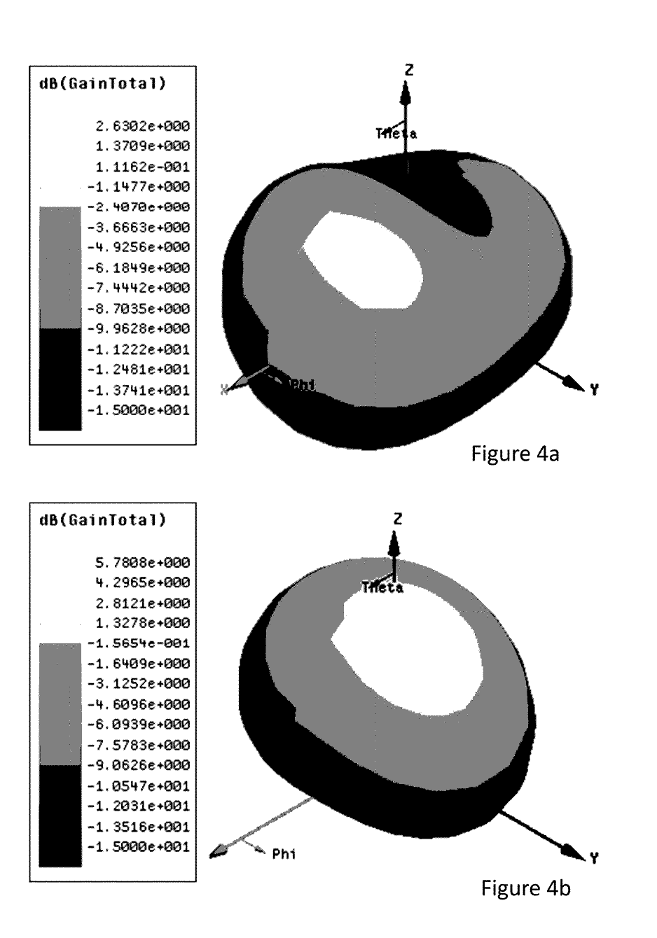

FIG. 4a shows a 3D simulated radiation pattern at a frequency of 2.4 GHz for an embodiment of an antenna shown in FIG. 2. There is minimal radiation in the vertical direction indicated by the z-axis which is advantageous for on-body links.

FIG. 4b shows a 3D simulated radiation pattern at a frequency of 2.48 GHz for an embodiment of an antenna shown in FIG. 2. The radiation is optimized for connecting to an off-body gateway as well as being isolated from the lossy body tissue.

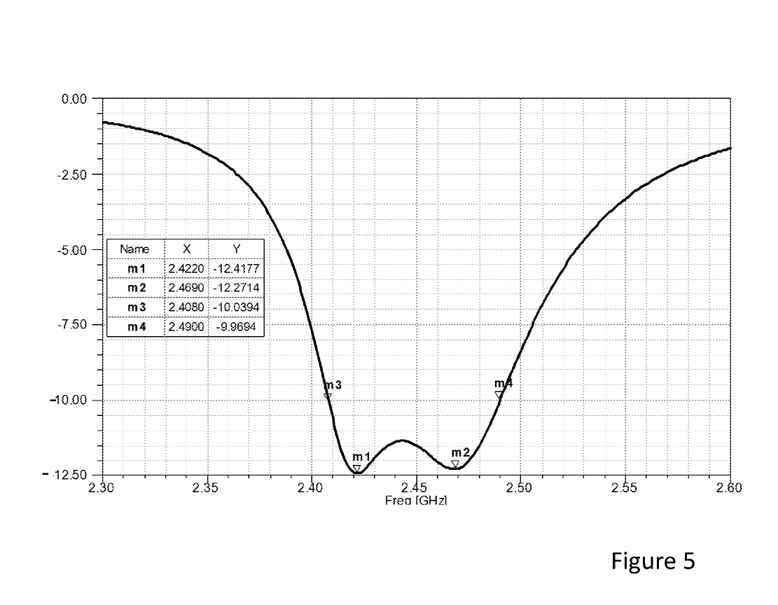

FIG. 5 shows the frequency characteristics of an antenna with the dimensions described above. The two different modes and their frequency coverage can be seen in FIG. 5. As shown in FIG. 5, there is a first resonance at approximately 2.42 GHz. This corresponds to the on-body mode described above in relation to FIG. 4a. There is a second resonance at approximately 2.47 GHz, this corresponds to the off-body mode described above in relation to FIG. 4b. The operating frequency range of the antenna is 2.4 GHz to 2.5 GHz.

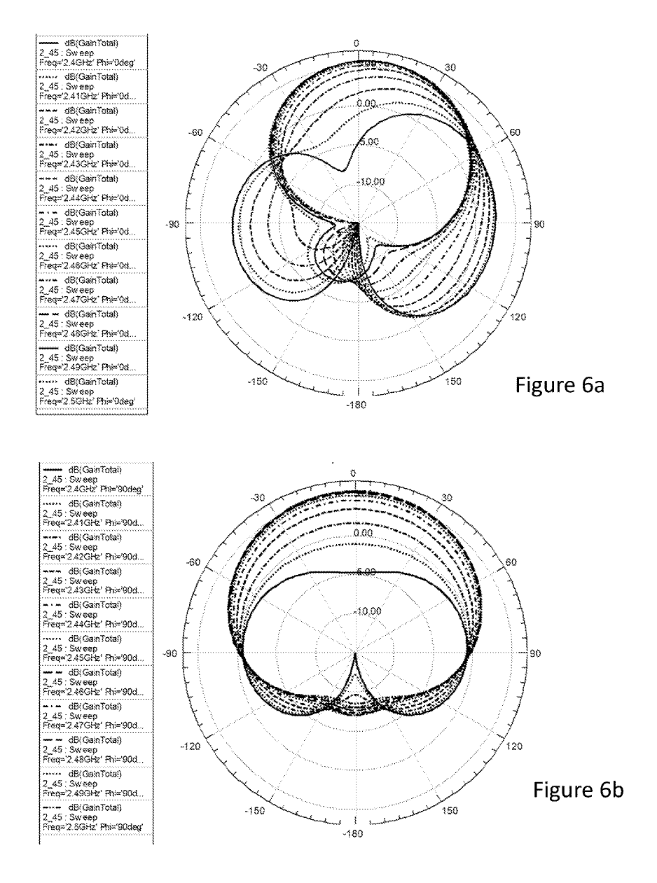

FIG. 6a shows the radiation pattern of an antenna as described with reference to FIG. 2 for the phi=0 plane (that is the plane running vertically through the antenna as shown in FIG. 2). FIG. 6b shows the radiation pattern of an antenna as described with reference to FIG. 2 for the phi=90 plane (that is the plane running horizontally through the antenna as shown in FIG. 2). As shown in FIG. 6, for a frequency of 2.4GHz, there the radiation is concentrated in the horizontal direction (−90 degrees and +90 degrees). As the frequency is increased to 2.5 GHz the radiation in the vertical direction increases. Thus frequency channels close to 2.4 GHz can are used for on-body communication and frequency channels close to 2.5 GHz are used for off-body communication.

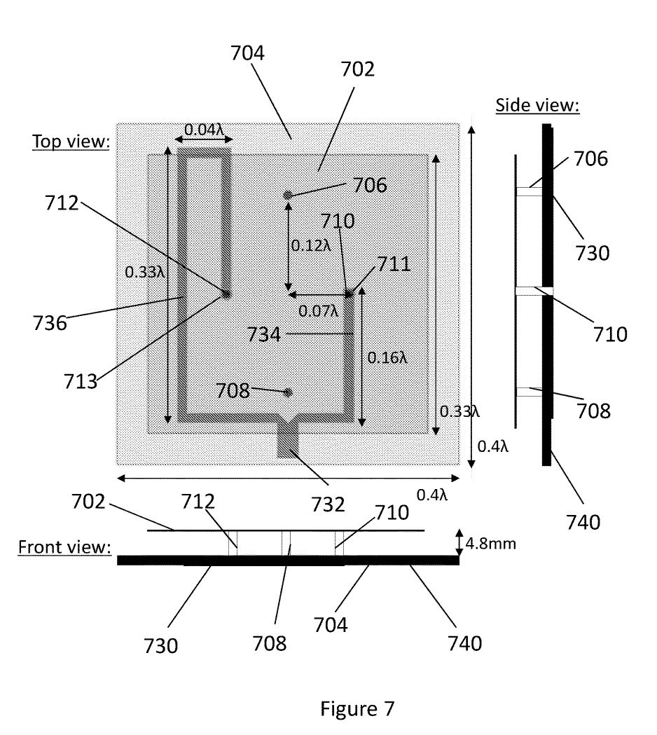

FIG. 7 shows an antenna 700 according to an embodiment. The antenna 700 has a size of approximately 0.4λ₀ by 0.4λ₀ where λ₀ is the wavelength of the radiation that the antenna is intended to transmit and/or receive. The radiation pattern diversity is again aimed for a combination of a directional mode and an omni-directional mode with the same intention as the antenna shown in FIG. 2.

The antenna 700 has a conductive radiating plane 702 and a grounded conductive ground plane 704. In the embodiment shown, the radiating plane 702 and the ground plane 704 are both square. The radiating plane 702 and the ground plane 704 are located parallel to one another and separated by a distance of 4.8 mm. The radiating plane 702 has sides of a dimension 0.4 λ₀ and the ground plane 704 has sides of a dimension 0.33 λ₀. In the embodiment shown in FIG. 7, the ground plane 704 is larger than the radiating plane 702. The centre of the radiating plane 702 is located above the centre of the ground plane 704. The ground plane 704 extends beyond the radiating plane 702 by an equal amount at each side of the antenna 700.

The radiating plane 702 is electrically connected to the ground plane 704 by two shorting pins 706 & 708. The shorting pins are arranged at locations which are symmetrical with respect to the centre of the radiating plane 702. The centres of the radiating plane 702 and the ground plane 704 are on the same axis. A first shorting pin 706 and a second shorting pin 708 are located on a first axis of symmetry of the radiating plane 702 which is normal to the sides of the radiating plane 702. The shorting pins are located a distance 0.12 λ₀ from the centre of the radiating plane.

Two feeding pins are connected to the radiating plane 702. A first feeding pin 710 and a second feeding pin 712 are located on a second axis of symmetry of the radiating plane 702 which is normal to the sides of the radiating plane 702 and normal to the first axis of symmetry. The ground plane has a first circular slot 711 and a second circular slot 713. The first feeding pin 710 passes through the first slot 711. The second feeding pin 712 passes through the second slot 713. The slots each have a radius of which is greater than the radius of the feeding pins. The first feeding pin 710 and the second feeding pin 712 are each located a distance of 0.07 λ₀ from the centre of the radiating plane 702.

A microstrip feed line 730 is arranged beneath the ground plane 704. A substrate 740 separates the feed line 730 from the ground plane 704. The feed line 730 starts at a connection point 732 which is attached to a connector. The connector may be implemented as an SMA connector includes a connection to the feed line and a ground connection to the ground plane. The feed line 730 has a T-junction at which it splits into a first branch 734 and a second branch 736. The first branch 734 connects to the first feeding pin 710 and the second branch 736 connects to the second feeding pin 712. The first feeding pin 710 and the second feeding pin 712 extend through the substrate to connect with the feed line 730.

As shown in FIG. 7, the first branch 734 is shorter than the second branch 736.

Because the first branch 734 and the second branch 736 have different lengths, the phase difference between the input signal at the first feeding pin 710 and the second feeding pin 712 will vary with the frequency of the input signal. The radiation pattern emitted by the antenna is dependent upon the phase difference. Therefore, the radiation pattern can be changed by changing the frequency of the input signal. The lengths of the first branch 734 and the second branch 736 are selected so that the phase difference between the input signal at the first feeding pin 710 and the second feeding pin 712 is on the border line of 90 degrees, For 2.5 GHz the phase difference is more than 90, for 2.4 GHz the phase difference is less than 90 degrees. With this length, a structure where both radiation modes, tm00 and tm01, are matched and their operating frequencies are within 2.4 GHz ISM band is achieved. These operating frequencies can be decreased by increasing the phase shift.

The omnidirectional mode and the directional mode are merged into the 2.4 GHz ISM band, therefore by changing the channels the maximum radiation direction is changed.

With the dimensions given in FIG. 7, 1.4 dB maximum gain is observed for the on-body mode at 2.41 GHz and 3.6 dB maximum gain for the off-body mode is observed at 2.5 GHz.

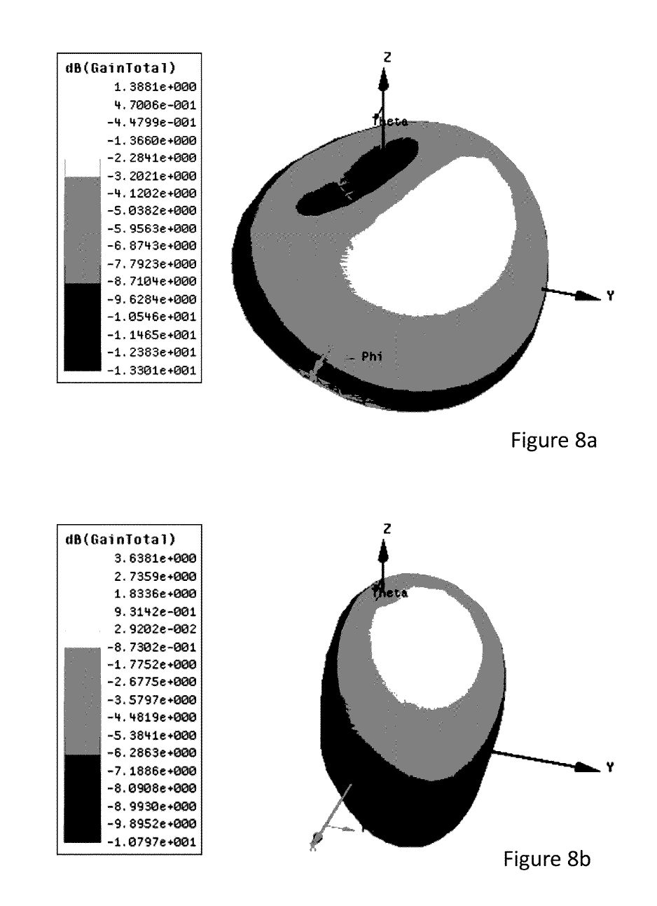

FIG. 8a shows a 3D simulated radiation pattern at a frequency of 2.41 GHz for an embodiment of an antenna as described with reference to FIG. 7. There is minimal radiation in the vertical direction which is a big advantage for on-body links.

FIG. 8b shows a 3D simulated radiation pattern at a frequency of 2.5 GHz GHz for an embodiment of an antenna as described with reference to FIG. 7. The radiation is optimized for connecting to an off-body gateway as well as being isolated from the lossy body tissue.

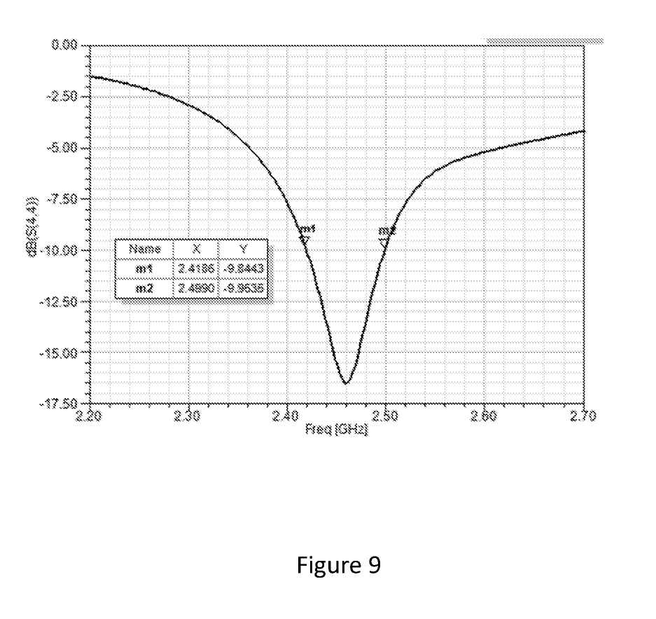

FIG. 9 shows the frequency characteristics of embodiment of an antenna as described with reference to FIG. 7.

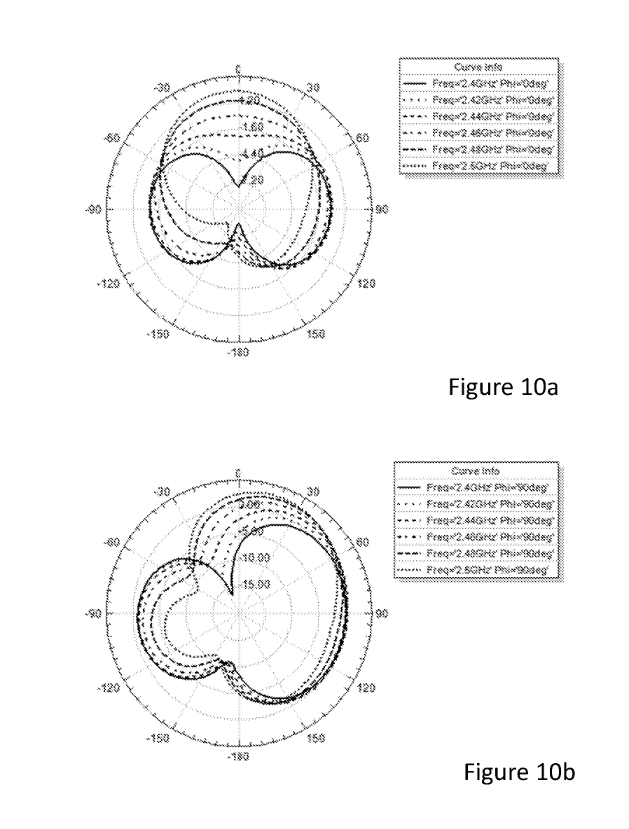

FIG. 10a shows the radiation pattern of an antenna as described with reference to FIG. 7 for the phi=0 plane (that is the plane running vertically through the antenna as shown in FIG. 7). As shown in FIG. 10a, for a frequency of 2.4 GHz, there is minimal radiation in the 0 and 180 degree directions. As the frequency is increased to 2.5 GHz, the radiation in the 0 degree direction increases.

FIG. 10b shows the radiation pattern of an antenna as described with reference to FIG. 7 for the phi=90 plane (that is the plane running horizontally through the antenna as shown in FIG. 7). As shown in FIG. 10b, for a frequency of 2.4 GHz, there is minimal radiation in the 0 and 180 degree directions. As the frequency is increased to 2.5 GHz, the radiation in the 0 degree direction increases.

The antennas described above may be implemented using standards such as the Bluetooth low energy standard or a version of the Zigbee standard such as ZigBee Health Care 1.0. If the Bluetooth low energy standard is used, 10 channels can be used to connect on-body links and the remaining 30 channels can be used for off-body links. If Zigbee is preferred, channel 11, 12, 13 and 14 can be used to connect on-body links while channel 15-26 will be more suitable for off-body links. Note that the Zigbee channels 1-10 are located in the 915 MHz ISM Band. The number of channels can be adjusted according to the needs of the system by changing the operating frequency of each mode.

Embodiments allow the realisation of different modes within the same frequency band intentionally to achieve steering with a single antenna by just changing the frequency channels across the operating band. It is to be noted that the antenna of the embodiments differ from known multiband antenna in that, whilst in the known antenna different modes are achieved at different centre frequencies, the antennae of the embodiments generate the different modes, so that their modes overlap with each other. In particular, in preferred embodiments, the two modes overlap with each other, so that the return loss of the antenna is never less than 6 dB, more preferably never less than 10 dB. The frequency channels available for selection may, for example be in bands of frequency ranges (the operating bands) that have been allocated/reserved for use by cellular phones, for use in WLAN/VViFi/802.11 the industrial, scientific and medical (ISM) radio bands, such as the above mentioned 2.4 GHz ISM band or the above mention 915 MHz ISM band. The channels available for selection are located within the same one of these bands, so that different modes/radiation patterns can be generated by switching from one operating frequency/frequency channel to another within the band. It will, however, be appreciated that the frequency band does not have to be a frequency band reserved for a particular use. Instead, the operating frequencies available for selection/generating the radiation patterns may be within/the antenna may have a fractional bandwidth of less than 20% or, more preferably approximately or less than 5%. The channel selection algorithm can be modified accordingly where the channels can be pre-mapped for expected Direction of Arrival (DoA) of specific links.

The channels available for selection within the frequency bands can be predetermined channels, such as the above mentioned Zigbee channels, the channels of the Bluetooth standard, or any channels predefined in standards associated with any of the above mentioned frequency bands, for example.

The radiation modes generated for the different frequency modes are such that in at least one radiation mode the antenna cannot facilitate data exchange with a point in space but so that in a different radiation mode data communication with this point in space is facilitated by the antenna. Alternatively or additionally the radiation modes are, in one embodiment, such that one radiation mode rejects or is not sensitive to interference that the other radiation mode is sensitive to. Examples of such modes are the above mentioned tm00 and tm01 modes as well as the tm02, tm03, tm10, tm20 and tm30 modes. It will be appreciated that the first radiation mode and the second radiation mode cannot be the same. However, embodiment envisage any combination of the radiation modes mentioned herein.

In embodiments, the configuration and dimensions of the antenna are optimized in such a way that the first radiation mode (omni-directional mode) and the second radiation mode (directional mode) both fall within the operating frequency range which is particularly useful for BAN where on-body links and off-body links require distinct radiation patterns.

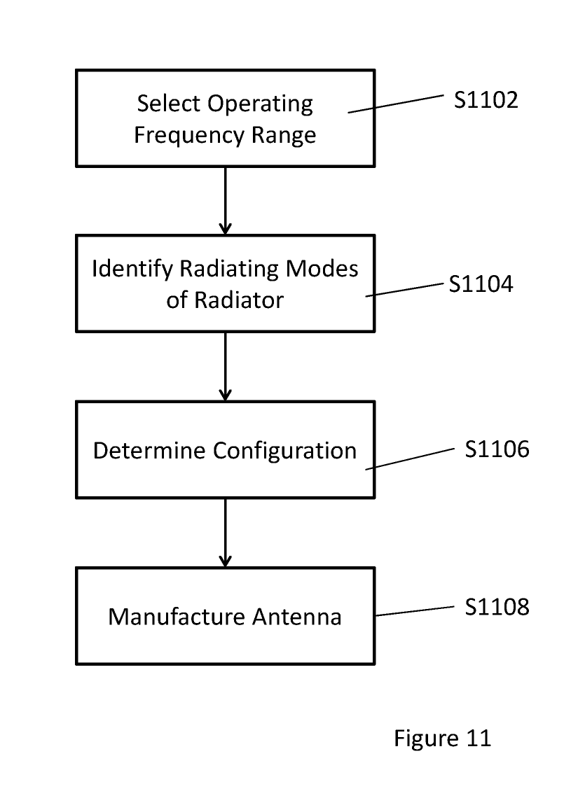

FIG. 11 shows a method of manufacturing an antenna according to an embodiment. In step S1102, an operating frequency range is identified. In step S1104, radiating modes of a radiator are identified. If the antenna is to be used in a body area network these modes will correspond to an on-body mode and an off-body mode. In step S1106, a configuration for the antenna is determined so that both of the modes fall within the operating frequency band. As discussed above, the configuration may be the locations for shorting pins and the dimensions of a planar patch radiator. The configuration may include the location of a feed point or feed points. The configuration may be the configuration of a feed element with two feed lines of different length as described in relation to FIG. 7. In step S1108, the antenna is manufactured according to the configuration.

While certain embodiments have been described, these embodiments have been presented by way of example only and are not intended to limit the scope of the inventions. Indeed, the novel antennas described herein may be embodied in a variety of other forms; furthermore, various omissions, substitutions and changes in the form of the antennas described herein may be made without departing from the spirit of the inventions. The accompanying claims and their equivalents are intended to cover such forms or modifications as would fall within the scope and spirit of the inventions

1. An antenna comprising a planar patch radiator, which, on excitation by an input signal having a first frequency within a predetermined frequency range is operable in a first radiation mode with a first radiation pattern, and on excitation by an input signal having a second frequency within the frequency range is operable in a second radiation mode with a second radiation pattern.

2. An antenna according to claim 1, wherein the first radiation pattern is an omni-directional pattern and the second radiation is a directional radiation pattern.

3. An antenna according to claim 1 or 2, wherein the predetermined frequency range is a frequency band reserved for use by cellular phones, for use in WLAN/VViFi/the 802.11 standard and/or the industrial, scientific and medical (ISM) radio bands.

4. An antenna according to claim 1 or 2, wherein the radiator has a fractional bandwidth of less than 20%, or approximately or less than 10% or approximately or less than 5%.

5. An antenna according to any preceding claim, configured for use in a body area network, wherein the first mode is an on-body mode and the second mode is an off-body mode.

6. An antenna according to any preceding claim wherein the first and second radiation modes overlap with each other, so that, the return loss of the antenna is, between the first and second frequency, never less than 6 dB.

7. A body area network comprising one or more antenna as claimed in any preceeding claim.

8. A method of operating an antenna that comprises a planar patch radiator, the method comprising:
operating the radiator in a first radiation mode with a first radiation pattern by exciting the radiator using an input signal having a first frequency within a predetermined frequency range; and
operating the radiator in a second radiation mode with a second radiation pattern by exciting by an input signal having a second frequency within the frequency range.

9. A method according to claim 8, wherein the first radiation pattern is an omni-directional pattern and the second radiation is a directional radiation pattern.

10. A method according to claim 8 or 9, wherein the predetermined frequency range is a frequency band reserved for use by cellular phones, for use in WLAN/VViFi/the 802.11 standard and/or the industrial, scientific and medical (ISM) radio bands.

11. A method according to claim 8 or 9, wherein the radiator has a fractional bandwidth of less than 20% or approximately or less than 10% or approximately or less than 5%.

12. An method according to any of claims 8 to 11, wherein the antenna is used in a body area network, wherein the first mode is an on-body mode and the second mode is an off-body mode.
